(19) United States
(12) Patent Application Publication
(10) Pub. No.: US 2008/0264211 A1
(43) Pub. Date: Oct. 30, 2008

(54) Goose Hammer

(76) Inventors: Juan Carlos Unda, Whittier, CA (US); Miguel Angel UndaLuquin, Whittier, CA (US)

Correspondence Address: WILSON DANIEL SWAYZE, JR., 3804 CLEARWATER CT., PLANO, TX, 75025, US

(21) Appl. No.: 11/741,491

(22) Filed: Apr. 27, 2007

(51) Int. Cl. B25D 1/12

(52) U.S. Cl. 81/22

(57) ABSTRACT

A hammer includes a handle including a shaft section, a pivoting device connected to an end of the shaft section to allow the hammer to the pivoted and a head and claw member including a sleeve section adapted to be movable along the shaft section of the handle. The head and claw member includes a body, an impact plate and a hammerhead. The sleeve section includes a elongate shaft passage to cooperate with the shaft, and the shaft section includes an outward projecting member to cooperate with the sleeve section and an aperture to cooperate with the outward projecting member. The pivot member includes a surface coated with a flexible material.

### FIELD OF THE INVENTION

This invention relates to impact tools such as hammers. More specifically, this invention relates to an improved hammer having a pivot member that can be extended with respect to a head and claw member.

### BACKGROUND OF THE INVENTION

Hammers of many sizes and shapes are available throughout the prior art, and typically include a handle connected to a head having at least one impact surface. The specific construction of the hammer handle and head, and even the striking surface, varies widely according to the desired specialized use of the hammer. That is, hammers for some applications are provided with heads formed from steel or the like to provide hard metallic impact surfaces. See, for example, U.S. Pat. No. 3,341,261. Alternately, for other applications hammers are provided with heads formed from soft compositions such as lead or rubber to provide soft, non-marring impact surfaces. See, for example, U.S. Pat. No. 2,894,550. Further, some hammers are provided with pellet-filled heads for reducing dangerous recoil upon impact. See, for example, U.S. Pat. Nos. 2,604,914 and 2,737,216.

Another specialized hammer construction comprises a skeletal hammer head and handle wholly received within a resilient encasement to provide soft impact surfaces.

Most users of these types of hammers have difficulty pulling out nails because the prior art hammers do not provide sufficient leverage for especially long nails. Furthermore, if the user is operating the hammer from a ladder, this lack of leverage may result in the user providing an uneven force which may destabilize the user and ladder.

### SUMMARY

The goose hammer is a flexible yet very simple tool which can be used by any user to facilitate the removal of nails easier and faster. The goose hammer eliminates the need for the user to provide a separate leverage device in order to pull out the nail. As a consequence, the goose hammer increases performance. As disclosed, the goose hammer may be adjusted to three positions, but the principles of the goose hammer can be extended to additional positions to increase the flexibility of the goose hammer. The top surface of the goose hammer may include flexible material such as rubber to prevent the surface from being marred resulting from the use of the hammer.

A hammer includes a handle including a shaft section, a pivoting device connected to an end of the shaft section to allow the hammer to the pivoted and a head and claw member including a sleeve section adapted to be movable along the shaft section of the handle.

The head and claw member includes a body, an impact plate and a hammerhead.

The sleeve section includes a elongate shaft passage to cooperate with the shaft, and the shaft section includes an outward projecting member to cooperate with the sleeve section and an aperture to cooperate with the outward projecting member.

The pivot member includes a surface coated with a flexible material.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the goose hammer at a first position;

FIG. 2 illustrates a perspective view of the goose hammer at a second position;

FIG. 3 illustrates a perspective view of the goose hammer at a third position;

FIG. 4 illustrates an exploded view of the goose hammer in cross section;

FIG. 5 illustrates an exploded view of the goose hammer in a perspective view;

FIG. 6 illustrates a top view of the goose hammer;

FIG. 7 illustrates a front view of the shaft section and pivot member of the present invention;

FIG. 8 illustrates a side view of the shaft section and pivot member of the present invention.

### DETAILED DESCRIPTION

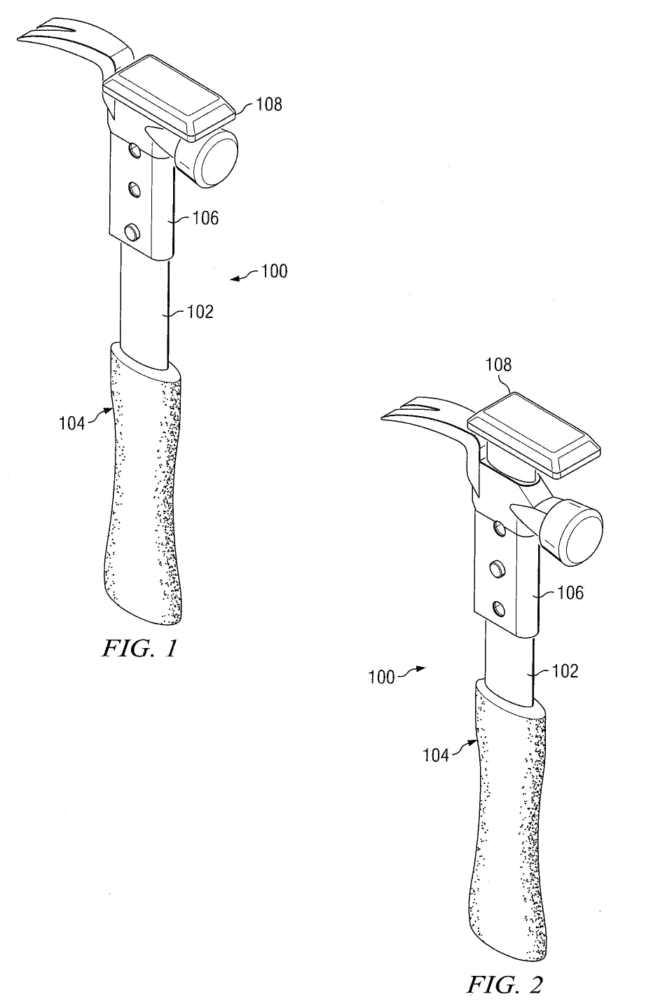

FIG. 1 illustrates the goose hammer 100 of the present invention. The goose hammer 100 includes a shaft section 102 of the handle 104, a pivot member 108 which allows the goose hammer 100 to pivot while removing a nail and a head and claw member 106 for traveling along the shaft section 102. FIG. 1 illustrates the head and claw member 106 at a first position where the pivot member 108 is substantially adjacent to head and claw member 106. The handle 104 is shown with an optional handle grip, which may be made from a rubber material.

The handle 104 may be any number of conventional handles, including handles made from wood, plastic, and fiberglass.

FIG. 2 illustrates the goose hammer 100 where the head and claw member 106 has traveled along the shaft section 102 of the handle 104 to a second position, allowing the pivot member 108 to extend a first predetermined distance from the head and claw member 106 to provide for additional pivot action for the goose hammer 100.

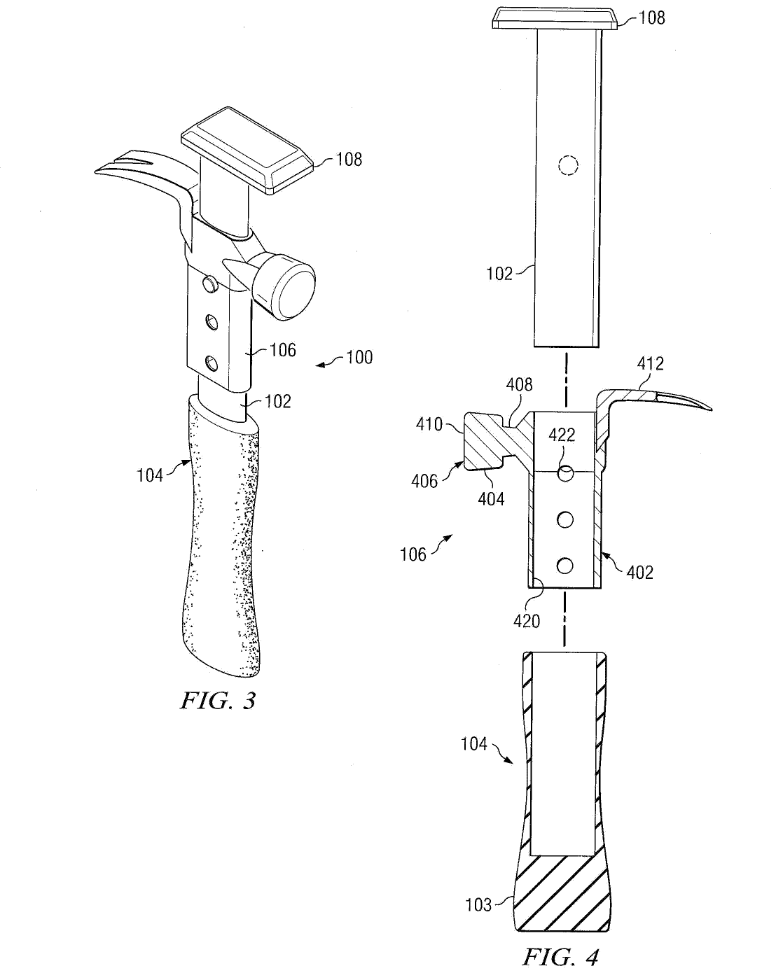

FIG. 3 illustrates the goose hammer 100 where the head and claw member 106 has traveled along the shaft section 102 of the handle 104 to a third position, allowing the pivot member 108 to further extend to a second predetermined distance from the head and claw member 106 to provide for further pivot action for the goose hammer 100.

FIG. 4 illustrates an exploded view of a portion of the goose hammer 100 in cross section. More specifically, FIG. 4 illustrates head and claw section 106 and the bottom portion 103 of the handle 104. The head and claw section 106 includes an impact section 406 which includes hammerhead 404 to connect the body 408 to the impact plate 410, body 408 to connect to the sleeve section 402 and the impact plate 410 to provide a striking surface. The head and claw section 106 additionally includes the sleeve section 402 to cooperate with the shaft section 102 and a L shaped claw section 412 for among other things removing nails. The sleeve section 402 includes an elongate shaft passage 420 to cooperate with the shaft section 102 to allow the head and claw section 106 to travel along the longitudinal direction of the shaft section 102. The sleeve section 102 additionally includes outward apertures 422 along a side of the sleeve section 102 to accept an outward projecting member 730 to lock the head and claw section 106 at the position on the shaft section 102. The hammerhead 404 is preferably cast from a steel material but alternatively may be forged from a steel block.

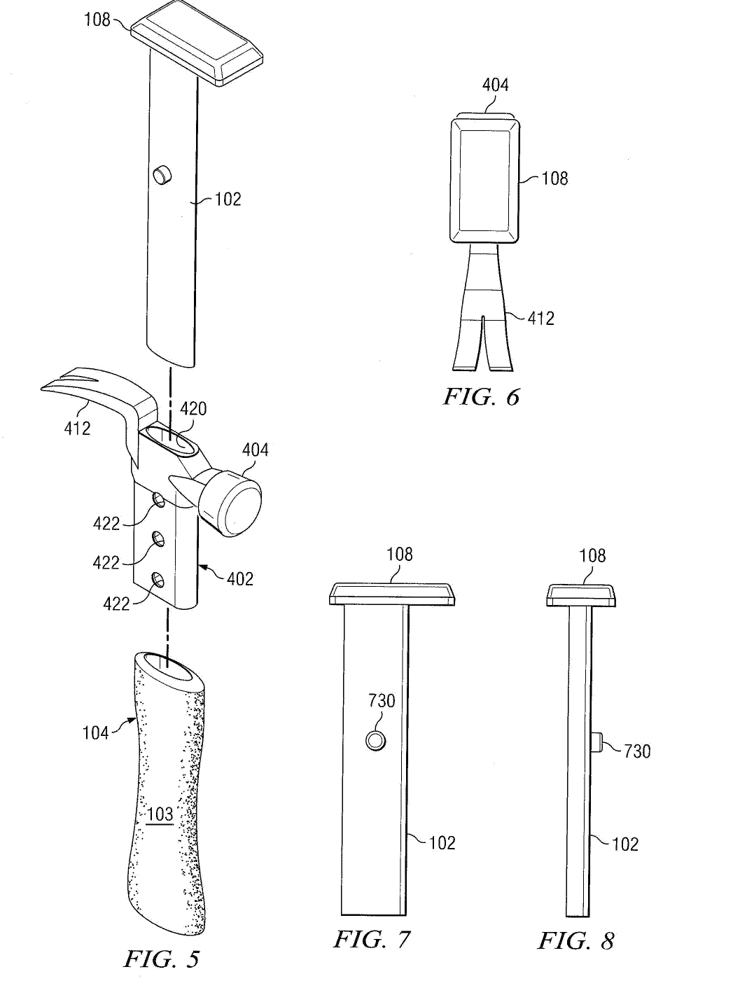

FIG. 5 illustrates an exploded view of a portion of the goose hammer 100 in a perspective view. The sleeve section 402 includes the elongated shaft passage 420 which extends in the longitudinal direction and through the sleeve section 402.

FIG. 6 illustrates a top view of the goose hammer 100 of the present invention. As shown in FIG. 6, a pivot member 108 is positioned between the hammerhead 404 and the claw section 412

FIG. 7 illustrates a side view of the pivot member 108 and the shaft section 102. FIG. 7 illustrates the outward projecting member 730 extending outward from the shaft section 102. The outward projecting member 730 cooperates with the outward aperture 422 to secure the head and claw member 106 at either the first position, the second position, or the third position.

FIG. 8 illustrates a end view of the pivot member 108 and the shaft section 102.

The top surface of the pivot member 108 may be coated with a flexible material in order to prevent marring of a surface which the pivot member 108 may be applied against.

The outward projecting member 730 is biased for example with a spring so that the outward projecting member 730 may be moved inwards so that the head and claw member 106 can be moved along the shaft section 102, and the outward projecting member of 730 is biased to be moved outwards to cooperate with the outward aperture 422 to lock the head and claw member 106.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A hammer, comprising:
a handle including a shaft section;
a pivoting device connected to an end of the shaft section to allow the hammer to the pivoted; and
a head and claw member including a sleeve section adapted to be movable along said shaft section of said handle.

2. A hammer as in claim 1, wherein said head and claw member includes a body.

3. A hammer as in claim 1, wherein said head and claw member includes an impact plate.

4. A hammer as in claim 1, wherein the head and claw member includes a hammerhead.

5. A hammer as in claim 1, wherein the sleeve section includes a elongate shaft passage to cooperate with the shaft.

6. A hammer as in claim 1, wherein the shaft section includes and an outward projecting member to cooperate with said sleeve section.

7. A hammer as in claim 6, wherein the sleeve section includes an aperture to cooperate with said outward projecting member.

8. A hammer as in claim 1, wherein said pivot member includes a surface coated with a flexible material.
